(19) United States
(12) Patent Application Publication
(10) Pub. No.: US 2006/0102279 A1
(43) Pub. Date: May 18, 2006

(54) Method for drawing tight and leveling seams of stone-like slabs

(76) Inventors: John Victor Sagrati JR., West Falls, NY (US); Jeffrey Alton Tucker, Niagara Falls, NY (US); Donald Bruce Williams, Rochester, NY (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/953,733

(22) Filed: Sep. 29, 2004

(51) Int. Cl. B29C 65/00

(52) U.S. Cl. 156/304.1

(57) ABSTRACT

A process is disclosed for seaming heavy slabs. The process employs low friction materials that allow easy manipulation of the slabs, resulting in an inconspicuous seam.

### BACKGROUND OF THE INVENTION

1. Field of Invention

The present invention relates generally to adhesively bonding sheets or slabs of stone or stone-like surface coverings. More particularly, the invention relates to the type of stone slabs generally found on kitchen countertops.

2. Description of the Related Art

In U.S. Pat. No. 5,042,772 Madeski discloses a mirror aligning device for shifting two mirrors relative to one another after the two mirrors have been adhesively secured to a room wall surface. The method disclosed for using the claimed device does not allow the easy and precise alignment of heavy slabs such as granite and engineered stone. The friction of the mastic adhesive would cause an unacceptable racking and subsequent misalignment of the slabs.

In U.S. Pat. No. 5,135,207 Bleaney discloses an apparatus for holding and mutually aligning sections of a countertop. Bleaney, however, does not disclose a means for removing the inherent friction in moving heavy slabs.

Currently, all known stone installation methods produce a visible seam. The solid surface industry has produced a seamless appearance and consumers desire this appearance in stone installations. Efforts to achieve this appearance in stone are frustrated by the inherent friction of the slab on the structure which supports it. This friction leads to a torque which causes the stone slabs to rack out of position as they are brought into alignment and preventing the seam from closing. There is a need for a low friction method for aligning and seaming heavy slabs.

### SUMMARY OF THE INVENTION

A method is disclosed for assembling and adhesively bonding two or more slabs of surfacing materials comprising the steps of preparing an edge of each slab to have a dry-fit seam gap less than 0.010 inch with an appropriate relief for adhesive flow, placing low-friction glides on the support structure, clamping said slabs together to a seam gap less than 0.015 inch, opening said seam gap at least 0.020 inch, applying an adhesive into the seam gap, and clamping said slabs to a seam gap less than 0.015 inch. Another embodiment of the invention is a glide for positioning and adhering a slab to a support structure. The glide comprises at least a first and second piece of low friction material with caulk between all pieces of friction material.

### BRIEF DESCRIPTION OF THE DRAWINGS

The invention may be better understood by reference to the accompanying drawings.

FIG. 1 is an overall view of the support structure and slabs to be seamed.

FIG. 2 shows the rebated slabs.

FIG. 3 shows various embodiments of the low friction glides.

### DETAILED DESCRIPTION OF THE PREFERRED EMBODIMENTS

Consumer acceptance of seamed slabs for a countertop is dependent on inconspicuous seams. The term “inconspicuous seam” is used with the meaning commonly accepted in the marketplace wherein the seam is not visually detectable at a normal viewing distance and is not perceptible to the sense of touch. It is understood for purposes of this invention that stone means natural stone such as granite, onyx, limestone, soapstone, and marble as well as stone-like materials such as engineered stone products such as Zodiaq® Quartz Surfacing (supplied by E. I. DuPont de Nemours, Wilmington, Del.), and large format ceramic tile slabs.

The two critical steps to achieving inconspicuous seams in a stone or engineered stone countertop are creating a small seam gap, and aligning the top surface elevations. Bringing the upper surface of two slabs into a common plane is commonly known as surface registration. For purposes of this invention, “register” will mean to bring the upper surface of two slabs into a common plane. Current best practices for stone and engineered stone typically produce a seam gap, of about 1/32″ (0.03125 inches (0.8 mm). The method of the current invention produces seam gaps between from 0.015″ to 0.003″ (0.38 mm to 0.08 mm).

The final seam gap is a function of the dry fit tolerance, the ability to draw the seam tight with adhesive applied, the ability to squeeze excess adhesive out of the seam, and the ability to hold the pieces in register until the adhesive cures. With respect to surface registration, the human hand can easily detect the thickness of a sheet of paper, approximately 0.003″ (0.38 mm), meaning that an inconspicuous seam must be vertically registered to less than that dimension, preferably around 0.001″ (0.025 mm).

Dry-fit tolerance, otherwise known as cut precision, is a function of the quality of the cutting and/or grinding equipment used. To enable the method of the current invention, the dry-fit seam gap (100), which is the seam gap fit before adhesive is applied, must be less than the finished gap, meaning dry-fit seam gaps should not exceed 0.010 inches (0.254 mm), or roughly the thickness of a business card. The method of the current invention produces dry gaps of about 0.003 inches (0.08 mm), or roughly the thickness of a piece of paper. The preferred cutting equipment is a beam saw. A typical saw may be used for cutting only when used in conjunction with an edge polisher. The edges being seamed must be free from excessive chip-out on the top surface. When the slabs (200) are fit together, the gap between the seam edges should not exceed 0.015″0 (0.38 mm). More preferably no gap should be larger than 0.010 inch, and most preferably no larger than 0.003. If the top edge is “broken” or beveled with abrasives such as sandpaper, to smooth chip-out, the gap at the widest part should not exceed the stated values.

The seam gap is also dependent on the ability to draw a seam tight and squeeze out excessive adhesive. This is a function of friction between the support structure and the stone slabs, clamping grip, clamp force, and rheology of the adhesive. Typically the support structure (110) will be kitchen cabinetry and it will be comprised of wooden components. Low friction glides, or shims, (121) are employed in the method of the current invention to reduce the clamping forces needed. The glides combine the two functions of reducing friction, and supporting the slab. The glides may be strips of low friction plastic such as high molecular weight polyethylene, ultra high molecular weight polyethylene, Delrin® polymer, or, preferably, Teflon® polyetetrafluoroethylene (both supplied by E. I. du Pont de Nemours and Company, Wilmington, Del.). Glides of varying thickness may also be used, independently (121) or stacked (120), to level the surface and support the slabs. Stacking the glides further reduces frictional forces because sliding will occur between the plastic glides (as each glide will more readily “stick” to its adjacent cabinet or slab surfaces). The stacked glides may be flat (121), or wedge-shaped (123) to allow ready adjustment of the overall height of the glide. One purpose of the glide is to reduce the coefficient of static and sliding friction.

A long strip of low friction material is placed along the top of the cabinet to reduce frictional forces opposing slab positioning and clamping movement. The coefficient of static friction for the underside of a stone slab on wood is roughly equivalent to that of the published values of either wood on wood, or cast iron on wood, which is 0.6 and the coefficient of sliding friction is 0.48. These frictional forces are so high as to require large forces to move heavy stone slabs into position.

A large difference between static and sliding coefficients of friction causes a slab to jump or overshoot the desired position while trying to move it into position. Use of low friction material glides as contact points between the slab and the support structure greatly reduces the difference between sliding and static coefficients, and jumping and overshooting while positioning the slabs are eliminated. The coefficient of friction between two pieces of Teflon® polytetrafluoroethylene, both sliding or static, is 0.04. This represents a 93% reduction in force required to start the slab moving as well as a 90% reduction of force versus sliding frictional values. Importantly, because there is no difference between sliding and static frictional values, there is no jump occurring as the slab begins to move. The slab moves fluidly.

Another purpose of the glide is to permanently support the slab on the support structure. A preferred embodiment of the glide has an adhesive or a caulk, such as a silicone adhesive, added between (122) the individual strips (121 or 123) of low friction material to further reduce friction. Such adhesives or caulks typically have the property of being very slippery before setting up. This property is sometimes referred to as glubrication. The advantage of using adhesive or caulk for lubricant is they permit easy initial movement of the glides and then set to prevent movement after placement by adhesively bonding the slabs to the support structure. For purposes of this invention, glide is understood to mean a single piece of low friction material or a stack of low friction material pieces, and optionally a caulk or lubricant contained between the pieces of low friction material and the support structure.

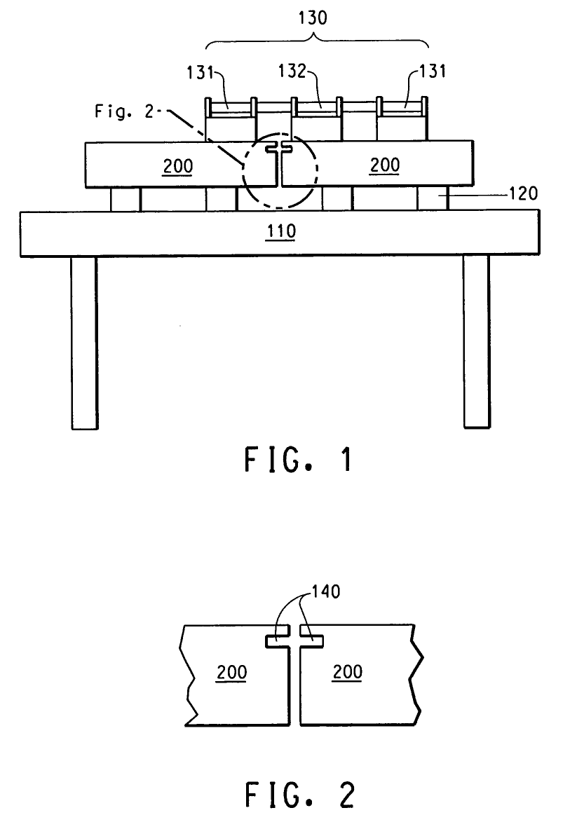

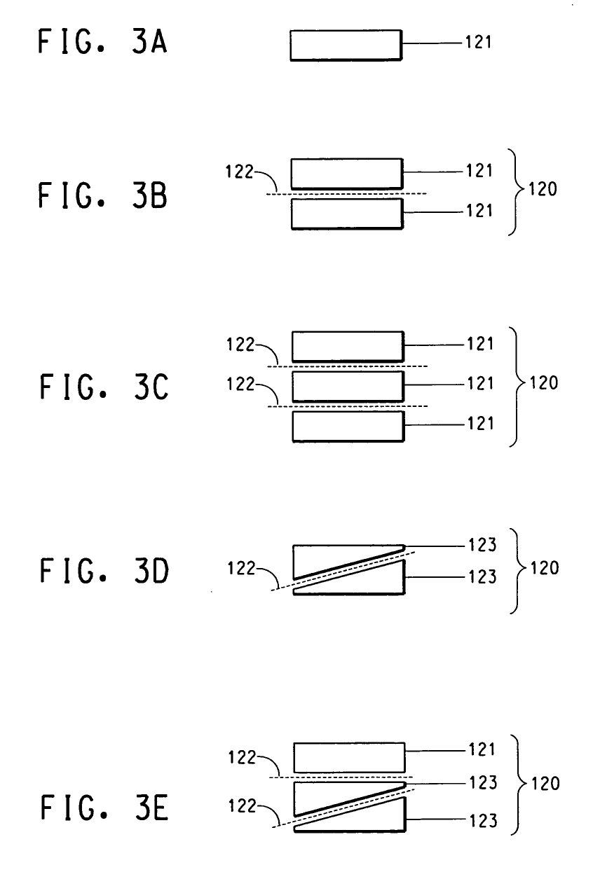

The clamp (130) employed in the process of the invention must be strong enough to move the slabs together on top of the structure, plus strong enough to overcome the resistance of the adhesive to flow out of the gap. The clamps are required to be strong enough to pull the slabs together, and have the ability to grip the slab during the pulling. Typical clamps are designed to install lower weight surfacing materials are found inadequate to bring the gap to less than 1/32″ of an inch. Further, due to limited gripping power and structural rigidity of typical clamps, vertical registration either cannot be achieved or cannot be maintained to provide a vertically inconspicuous seam. The method of the current invention uses a vacuum clamp as shown at (130) in FIG. 1. The clamp features three vacuum pads, one fixed on either end (131) and a center pad (132) capable of being adjusted vertically to register the slab surfaces. The clamp employs a continuous vacuum pump to obtain sufficient gripping strength as well as to maintain that gripping strength as the adhesive cures. Examples of such vacuum clamps are the Diamond Wright, available from GranQuartz of Tucker, Ga.; Edgemarc Tools of Vista Calif.; and the Parallign seam clamp from Monument Toolworks Inc. of Assonet, Mass.

A rubber sheet is adhered to the bottom of the vacuum pads for a higher coefficient of friction to prevent slippage, and to act as a bumper to prevent marring. By having strong gripping strength, a rigid structure, and a fine vertical adjustment, the clamp can register a surface very precisely.

Clamps of this type allow another embodiment of the invention. It is sometimes needed to redo a seam when the results are not satisfactory. The clamps are employed in reverse direction to break the seam. The seam is now done according to the process of the invention as if for any two slabs not previously seamed.

In order to squeeze excessive adhesive from the seam to leave the desired finished seam gap, the adhesive itself must be of a sufficient viscosity to enable it to flow. To aid this flow, a rebate (140) or relief is cut in the seam edge to allow a place for the adhesive to escape. The two types of adhesives commonly used for seams in the stone and engineered stone industry are knife-grade and flow-grade. Knife-grade adhesives are typically used to seam slabs of stone. Knife grade adhesives are found to have shear-thinning rheology with viscosities around 600 Pa·s (600,000 cp) for 1 sec-1 shear rates to 50 Pa·s (50,00 cp) for 10 sec-1 shear rates.

The term knife-grade derives from the designed intention for the adhesive to be applied with a putty knife, which requires the seam to be opened at least 1/16″, after dry fitting, to apply the adhesive. The higher viscosity of knife-grade adhesive is helpful to prevent the adhesive from running out before the seam can be drawn together. Knife grade adhesives may be used with this process but it is important to cut the rebate into the edge of the seam (140) but it is necessary to make sure the rebate does not extend completely into the front edge of the countertop where it would be visible. The rebate does not have to be that large, and is typically less than 1/16″, and is typically made by making one or two passes down the length of the seam with a grinder. The rebate can also be made during seam cutting by setting the cutting tool at an angle. Typically at least ¼″ is left at the top edge for joining to provide sufficient material to prevent chip-out during final edge dressing/polishing.

A further advantage of a rebate is that less material is needed to be polished at the edge, speeding the process and reducing tool wear. When flow grade adhesive is used in this method, the seam gap is only opened about 0.020″, which is just enough for the seam adhesive to run into the seam gap, as opposed to completely opening the seam as required with knife grade adhesive. Then, because of the ease of motion afforded by the clamps and glides, the seam can be quickly closed and tuned before the adhesive has a chance to run out or cure.

Typical flow grade seam adhesive viscosities are in the range of about 16 Pa·s (16,000 cp) to as low as 1 Pa·s (1,000 cp). The viscosity is dependent on many factors including cure time, shear thinning, and desired bond strength, but are lower than knife-grade to aid a tight squeeze. All seam adhesives, regardless of rheology, must be either transparent or sufficiently color matched, to match the adjoining color and translucency. Examples of adhesives are Marmorkitt 1000 by Akemi North America of Holbrook, N.Y.; Diarex® knife grade adhesives from GranQuartz of Tucker, Ga.; and Akabond 621 from Axson North America, Inc of Eaton Rapids, Mich.

The method for adhesively bonding two or more slabs of surfacing materials according to the process of the present invention comprises the steps of preparing an edge of each slab to have a dry-fit seam gap less than 0.010 inch, optionally rebating the seam edge to aid adhesive flow for adhesive, placing low-friction glides on a support structure, clamping the slabs together to a seam gap less than 0.015 inch, registering surfaces to within 0.003, opening the seam gap to apply adhesive, applying an adhesive into the seam gap, and clamping the slabs to a seam gap less than 0.015 inch. In some circumstances the clamp may raise the slab substantially higher than the height of the glide during the registration step which will necessitate adjusting or replacing the glides. Adjustment or replacement of glides must be done before adhesive is applied to the seam. Often, if the seam adhesive has shrunken into the seam after curing, a second coat, optionally a clear coat, is applied to the top of the seam and allowed to cure prior to clamp removal. The tape is removed and excess adhesive cleaned away such as with a razor blade.

The method of the invention allows for in-situ seaming on top of the final support structure, or in a workshop for subsequent installation on the final support structure. In the case of in-situ seaming, the support structure is typically kitchen cabinetry. The glides can be secured to the structure using caulk, or left free to move. In the case of seaming in a workshop, the support structure is typically a workbench and the glides must not be caulked in order to allow removal from the workbench and installation at the final support structure.

Advantages and various aspects of the invention are illustrated in the following examples.

### EXAMPLE 1

Slabs for a kitchen countertop to be fit were prepared by cutting to size and having their edges finished using a CMS® Brembana Speed 3 CNC machine. A bridge saw was used to cut the slabs into rough net shape. The seam flat edge grit finish was 120 grit. Edge finishing was performed with a multi-head hard diamond edge polisher. A rebate was ground into the seam edge. The slabs were then dry fit in the shop prior to field installation to insure good fit and dimensional accuracy.

In the field, the cabinets which served as the support structure were brought to level. Low friction glides were placed to bring the support structure to within 1/16 inch. Glides in a variety of sizes were stacked, or used singly as dictated on need based on the gap between the slab and cabinet top, and placed on the cabinets. In addition to the glides, strips of glide tape were placed along the cabinet top edge.

After leveling the cabinets and applying low-friction material tape, the slabs were placed in position on top of the glides previously placed atop the cabinets. Because of the low friction, the slabs were easily shifted. Front edges were aligned and seams inspected to insure a uniform seam gap less than 0.015 inch.

Tape was applied on either side of the dry fit seam gap to keep adhesive off the surface of the slabs. Parallign seam clamps were placed so the clamp pads (one on one side, the other two on the other side) straddled the seam. All valves were then closed and the vacuum pump turned on. The center retractable pad was lowered to contact the slab so the pad could “adhere” under vacuum pressure. Once a good seal was achieved, the center clamp was raised until a second pad began to close in on the slab. As it got close, the second pad's valve was opened and adjusted to get a seal. This process was repeated for the third pad so all pads were adhered. The slabs were brought together using the clamp. Once the slabs were close together (close gap), the center pad was retracted to register the top surfaces. The retractable pad was lowered and raided to fine tune vertical registration by continually running a razor blade edge or a finger over the seam until it could not be detected.

The seam gap for adhesive was opened by manually spreading the slabs about 0.020″. A bead of Marmorkitt 1000 adhesive was placed along the gap and given a minute to seep down into the seam. The seam was then opened enough to apply adhesive into the seam. Marmorkitt 1000 adhesive was allowed to run into the seam. The clamps were again tightened to close the seam and squeeze excess adhesive from the seam to achieve a finished gap between 0.015 and 0.003 for an inconspicuous appearance. The adhesive was allowed to cure before removing the clamps. Final treatment was to wipe the area clean with solvent and buff to a sheen.

### EXAMPLE 2

Clamps were placed on a slab which had been previously seamed such that the clamp pads straddled the existing seam (one on one side, the other two on the other side). All valves on the clamp were then closed and the vacuum pump turned on. The center retractable pad was lowered to contact the slab so the pad could “adhere” under vacuum pressure. Once a good seal was achieved, a second pad was lowered to close in on the slab. As it got close, the second pad's valve was opened and adjusted to get a seal. This process was repeated for the third pad so all pads were adhered. The existing seam was broken using the clamp. A new seam was created using the process of Example 1.

What is claimed is:

1. A method for adhesively bonding two slabs of surfacing materials, comprising the steps of:
(a) preparing an edge of each said slabs to have a dry-fit seam gap less than 0.010 inch;
(b) placing low-friction glides on a support structure wherein said slabs are to be supported;
(c) placing said slabs on said glides;
(d) clamping said slabs together to a seam gap less than 0.015 inch;
(e) registering upper surfaces of said slabs to within 0.003 inch;
(f) opening said seam gap;
(g) applying said adhesive into said seam gap; and
(h) clamping said slabs to a seam gap less than 0.015 inch.

2. A method for adhesively bonding two slabs of surfacing materials, comprising the steps of:
(a) preparing an edge of each said slabs to have a dry-fit seam gap less than 0.010 inch;
(b) rebating the seam edge to aid flow of an adhesive;
(c) placing low-friction glides on a support structure wherein said slabs are to be supported;
(d) placing said slabs on said glides;
(e) clamping said slabs together to a seam gap less than 0.015 inch;
(f) registering upper surfaces of said slabs to within 0.003 inch;
(g) opening said seam gap;
(h) applying said adhesive into said seam gap; and
(i) clamping said slabs to a seam gap less than 0.015 inch.

3. A method for reconstructing an adhesive seam in stone-like slabs, comprising the steps of:
(a) applying clamps with at least two vacuum pads across the adhesive seam;
(b) opening said seam by forcing said clamp pads apart;
(c) cleaning edges of said slabs;
(d) placing low-friction glides on a support structure wherein said slabs are to be supported;
(e) placing said slabs on said glides;
(f) clamping said slabs together to a seam gap less than 0.015 inch;
(g) registering upper surfaces of said slabs to within 0.003 inch;
(h) opening said seam gap;
(i) applying said adhesive into said seam gap; and
(j) clamping said slabs to a seam gap less than 0.015 inch.

4. A glide for positioning and adhering a slab to a support structure comprising:
(a) a first piece of low friction material; a second piece of low friction material; and
(a) caulk between said first piece of low friction material and said second piece of low friction material.

5. A glide for positioning and adhering a slab to a support structure comprising:
(a) a plurality of low friction material pieces; and
(b) caulk, wherein said caulk is placed between each piece of low friction material.

6. The glide of claim 5 wherein the low friction material pieces are wedge-shaped.
